(19) United States
(12) Patent Application Publication
(10) Pub. No.: US 2026/0269291 A1
(43) Pub. Date: Sep. 10, 2026

(54) FUEL CELL SYSTEM

(71) Applicant: Honda Motor Co., Ltd., Tokyo (JP)

(72) Inventor: Taishi Yamaguchi, Saitama (JP)

(21) Appl. No.: 19/554,655

(22) Filed: Mar. 3, 2026

(30) Foreign Application Priority Data
Mar. 5, 2025 (JP) 2025-034641

(51) Int. Cl. H01M 8/04992; H01M 8/04082; H01M 8/04119; H01M 8/0438; H01M 8/04537; H01M 8/04746; H01M 8/10

(52) U.S. Cl. CPC H01M 8/04992; H01M 8/04156; H01M 8/04201; H01M 8/04388; H01M 8/04604; H01M 8/04753; H01M 8/04761; H01M 2008/1095

(57) ABSTRACT

A fuel cell system including a water storage portion in which liquid water generated by power generation of a fuel cell, a drain valve provided in a drain flow path connected to the water storage portion, and a microprocessor controlling the injector to alternate between an injection and a non-injection of an anode gas according to a power generation load and controlling the drain valve to switch from an open position opening the drain flow path to a closed position blocking the drain flow path according to a pressure of the anode gas. The microprocessor is configured to switch the drain valve from the open position to the closed position based on a decrease rate of the pressure of the anode gas during a non-injection of the anode gas by the injector.

### CROSS-REFERENCE TO RELATED APPLICATION

This application is based upon and claims the benefit of priority from Japanese Patent Application No. 2025-034641 filed on Mar. 5, 2025, the content of which is incorporated herein by reference.

### BACKGROUND OF THE INVENTION

### Field of the Invention

This invention relates to a fuel cell system.

### Description of the Related Art

In recent years, technological developments have been made on a fuel cell that contribute to energy efficiency to ensure access to energy that is affordable, reliable, sustainable and advanced by more people. As a technology related to this type of fuel cell, a fuel cell system has been conventionally known that includes a water storage portion in a circulation flow path of a fuel gas to store liquid water generated by power generation, and the liquid water in the water storage portion is discharged by opening a drain valve. Such a system is described in, for example, Japanese Unexamined Patent Publication No. 2010-123427 (JP 2010-123427 A). The system described in JP 2010-123427 A includes a water level sensor that detects the water level of the liquid water, and switches the drain valve from an open state to a closed state based on a detection signal from the water level sensor.

However, the fuel cell system described in JP 2010-123427 A refers to the detection value of the water level sensor when switching the drain valve to the closed state. Therefore, the necessity of the water level sensor results in higher cost.

### SUMMARY OF THE INVENTION

An aspect of the present invention is a fuel cell system including: a fuel cell that generates power by being supplied with an anode gas and a cathode gas; an injector that injects the anode gas supplied to the fuel cell through an anode supply flow path; a water storage portion provided in an anode gas discharge flow path through which the anode gas discharged from the fuel cell flows, a liquid water generated by power generation of the fuel cell being stored in the water storage portion; a drain valve provided in a drain flow path connected to the water storage portion; a pressure detection part that detects a pressure of the anode gas in the anode supply flow path; a load detection part that detects a power generation load; and an electronic control unit including a microprocessor and a memory connected to the microprocessor. The microprocessor is configured to perform controlling the injector to alternate between an injection and a non-injection of the anode gas in accordance with the power generation load, and controlling the drain valve to switch from an open position opening the drain flow path to a closed position blocking the drain flow path in accordance with the pressure detected by the pressure detection part, the controlling the drain valve including switching the drain valve from the open position to the closed position based on a decrease rate of the pressure detected by the pressure detection part during the non-injection of the anode gas by the injector.

### BRIEF DESCRIPTION OF THE DRAWINGS

The objects, features, and advantages of the present invention will become clearer from the following description of embodiments in relation to the attached drawings, in which:

FIG. 1 is a diagram illustrating a schematic configuration of a fuel cell system according to an embodiment of the present invention;

FIG. 2 is a cross-sectional view of a main part of a fuel cell stack included in the fuel cell system in FIG. 1;

FIG. 3 is a block diagram illustrating a control configuration of the fuel cell system according to the embodiment of the present invention;

FIG. 4 is a time chart illustrating an example of an operation by a fuel cell system used as a reference example of the present embodiment;

FIG. 5 is a flowchart illustrating an example of processing performed by a controller in FIG. 3;

FIG. 6A is a diagram illustrating an example of an injection pattern of injectors in a second injection mode;

FIG. 6B is a diagram illustrating an example of an injection pattern of injectors in a third injection mode;

FIG. 7 is a flowchart illustrating another example of processing performed by a controller in FIG. 3;

FIG. 8 is a flowchart illustrating a modification of FIG. 5;

FIG. 9 is a time chart illustrating an example of an operation obtained by performing the flowchart in FIG. 8.

### DETAILED DESCRIPTION OF THE INVENTION

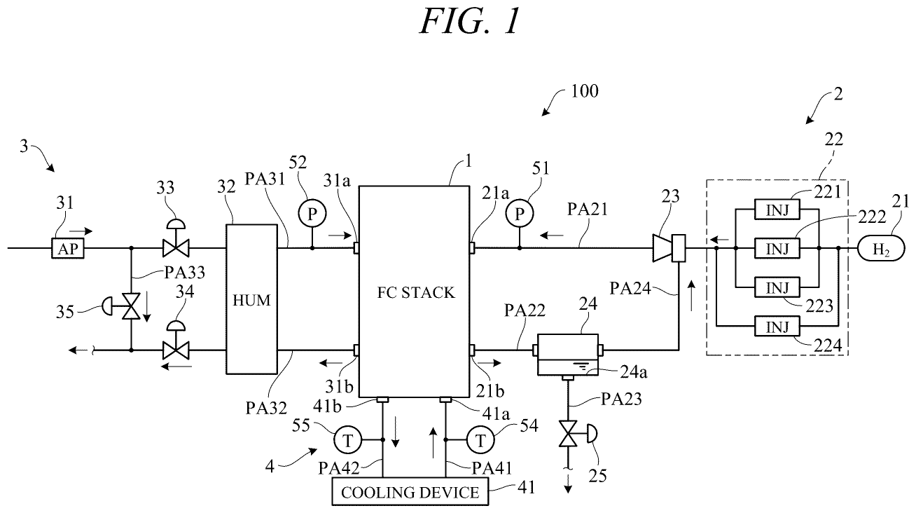

Hereinafter, an embodiment of the present invention will be described with reference to FIGS. 1 to 9. FIG. 1 is a diagram illustrating a schematic configuration of a fuel cell system 100 according to an embodiment of the present invention. The fuel cell system 100 of FIG. 1 is mounted on, for example, a vehicle (fuel cell vehicle) and generates electric power to be supplied to a travel motor of the vehicle.

As illustrated in FIG. 1, the fuel cell system 100 includes a fuel cell stack 1, a fuel gas supply and exhaust part 2 that supplies a fuel gas (anode gas) to the fuel cell stack 1 and discharges the fuel gas from the fuel cell stack 1, an oxidant gas supply and exhaust part 3 that supplies an oxidant gas (cathode gas) to the fuel cell stack 1 and discharges the oxidant gas from the fuel cell stack 1, and a cooling medium supply and exhaust part 4 that supplies a cooling medium to the fuel cell stack 1 and discharges the cooling medium from the fuel cell stack 1. The fuel gas is, for example, hydrogen. The oxidant gas is, for example, air containing oxygen. The cooling medium is, for example, water or a coolant liquid containing ethylene glycol or propylene glycol.

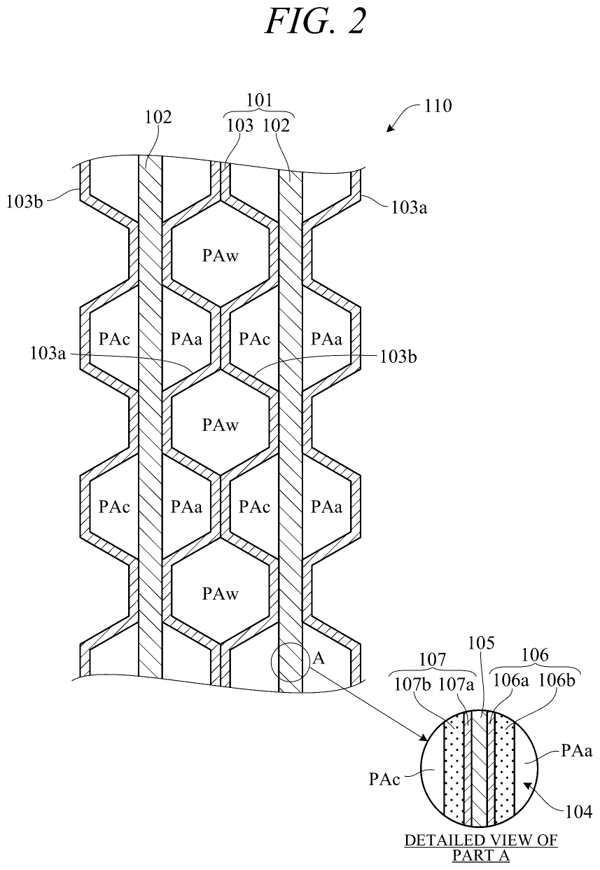

FIG. 2 is a cross-sectional view of a main part of the fuel cell stack 1. As illustrated in FIG. 2, the fuel cell stack 1 includes a cell stacked body 110 configured by stacking a plurality of power generation cells 101. The power generation cell 101 includes a unitized electrode assembly (UEA) 102 including a membrane electrode assembly (MEA) having an electrolyte membrane and electrodes, and a separator 103 alternately arranged with the unitized electrode assembly 102. The separator 103 integrally includes an anode separator 103a which is a plate member disposed facing one surface of the unitized electrode assembly 102, and a cathode separator 103b which is a plate member disposed facing the other surface of the unitized electrode assembly 102.

Inside the separator 103 enclosed by the anode separator 103a and the cathode separator 103b, a cooling flow path PAw through which a cooling medium flows is formed. The generating surface of the power generation cell 101 is cooled by the flow of the cooling medium. The surface of the separator 103 facing the unitized electrode assembly 102 is formed into an uneven shape by press molding or the like to form a gas flow path between the separator 103 and the unitized electrode assembly 102. An anode flow path PAa through which the fuel gas flows is formed in the recess between the unitized electrode assembly 102 and the anode separator 103a. A cathode flow path PAc through which the oxidant gas flows is formed in the recess between the unitized electrode assembly 102 and the cathode separator 103b.

FIG. 2 includes an enlarged cross-sectional view of the membrane electrode assembly 104 (detailed view of part “A”) as a cross-sectional view of the unitized electrode assembly 102. As illustrated in the detailed view of part “A” in FIG. 2, the membrane electrode assembly 104 has an electrolyte membrane 105, an anode electrode 106 provided on one surface of the electrolyte membrane 105, and a cathode electrode 107 provided on the other surface 232 of the electrolyte membrane 105. The electrolyte membrane 105 is, for example, a solid polymer electrolyte membrane, and a thin film of perfluorosulfonic acid polymer containing moisture can be used. Not only a fluorine-based electrolyte but also a hydrocarbon-based electrolyte can be used.

The anode electrode 106 has an electrode catalyst layer 106a formed on one surface of the electrolyte membrane 105 and served as a reaction field for electrode reaction, and a gas diffusion layer 106b formed on the surface of the electrode catalyst layer 106a on the opposite side of the electrolyte membrane 105 to spread and supply the fuel gas. The cathode electrode 107 has an electrode catalyst layer 107a formed on the other surface of the electrolyte membrane 105 and served as a reaction field for electrode reaction, and a gas diffusion layer 107b formed on the surface of the electrode catalyst layer 107a on the opposite side of the electrolyte membrane 105 to spread and supply the oxidant gas. Intermediate layers (underlayers) can also be provided between the electrode catalyst layer 106a and 107a and the gas diffusion layer 106b and 107b.

The electrode catalyst layers 106a and 107a include a catalyst metal that promotes the electrochemical reaction of hydrogen contained in the fuel gas and oxygen contained in the oxidant gas, an electrolyte (such as an ionomer) with proton conductivity, and carbon particles with electron conductivity, and the like. The gas diffusion layers 106b and 107b are made of conductive members with gas permeability, such as carbon porous bodies.

In the anode electrode 106, the fuel gas (hydrogen) supplied through the anode flow path PAa is ionized by an action of a catalyst, passes through the electrolyte membrane 105, and moves to the cathode electrode side. Electrons generated at this time pass through an external circuit and are extracted as electric energy. In the cathode electrode 107, an oxidant gas (oxygen) supplied via the cathode flow path PAc reacts with hydrogen ions guided from the anode electrode 106 and electrons moved from the anode electrode 106 to generate water. The generated water gives an appropriate humidity to the electrolyte membrane 105, and excess water is discharged to an outside of the unitized electrode assembly 102 along the gas flow. The generated water on the cathode side also flows to the anode side by back diffusion through the electrolyte membrane 105. Therefore, both the fuel gas and oxidant gas contain generated water.

As illustrated in FIG. 1, the fuel gas supply and exhaust part 2 includes a tank 21 in which fuel gas (anode gas) is stored, a fuel gas supply flow path PA21 for guiding the fuel gas in the tank 21 to the fuel gas inlet 21a of the fuel cell stack 1, and a fuel gas discharge flow path PA22 through which the fuel gas (fuel exhaust gas) discharged from the fuel gas outlet 21b of the fuel cell stack 1 flows. An injector 22 and an ejector 23 are arranged in the fuel gas supply flow path PA21. A gas-liquid separator 24 is connected to the fuel gas discharge flow path PA22.

The injector 22 is configured by multiple electromagnetic injectors connected in parallel. More specifically, the injector 22 has a plurality (three in FIG. 1) of large injectors 221 to 223 and a single small injector 224. The configurations of the plurality of large injectors 221 to 223 are equal to each other. The hole diameter of each of the large injectors 221 to 223 is larger than the hole diameter of the small injector. Therefore, the injection amount per one injection of each of the large injectors 221 to 223 is greater than the injection amount per one injection of the small injector 224, and the injection capacity of each of the large injectors 221 to 223 is higher than the injection capacity of the small injector 224. The number of large injectors 221 to 223 and small injector 224 connected in parallel is not limited to those described above.

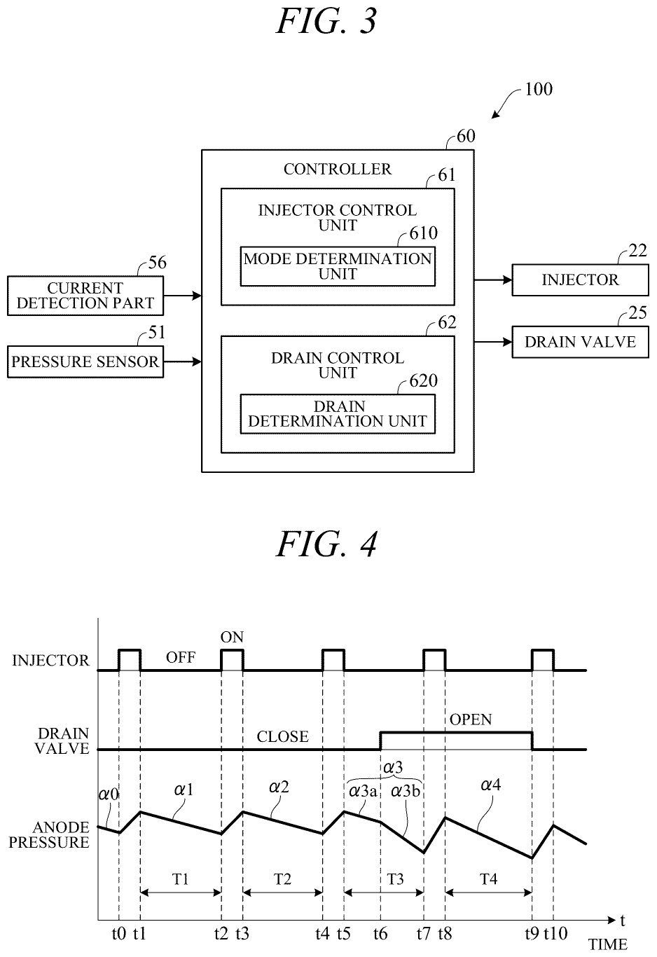

The injector 22 is driven in response to a drive command from the controller 60 (FIG. 3). The fuel gas is injected toward the ejector 23 by the operation of the injector 22. The injector 22 functions as a gas supply part that supplies the fuel gas to the fuel cell stack 1. The ejector 23 includes a nozzle section, a suction section, a merging section, and a diffuser section. The fuel gas injected from the injector 22 passes through the small-diameter nozzle section and then flows into the diffuser section via the merging section. The fuel gas that has passed through the ejector 23 is supplied to the fuel cell stack 1 via the fuel gas inlet 21a. The ejector 23 may be configured by a plurality of ejectors connected in parallel instead of a single ejector. For example, the ejector 23 may be configured by providing a large ejector connected to the large injectors 221 to 223 and a small ejector connected to the small injector 224 in parallel.

The fuel gas discharged from the fuel gas outlet 21b, that is, the fuel exhaust gas (anode off-gas), is separated into fuel gas and water by the gas-liquid separator 24. A drain flow path PA23 is connected to the gas-liquid separator 24, and an electromagnetic drain valve 25 is interposed in the drain flow path PA23. The drain valve 25 is configured to be switchable between an open position and a closed position. The liquid water separated by the gas-liquid separator 24 is stored in the water storage portion 24a of the gas-liquid separator 24. When the drain valve 25 is opened, the liquid water in the water storage portion 24a is discharged to the outside through the drain flow path PA23 and the drain valve 25. When the drain valve 25 is closed, the drain flow path PA23 is blocked, and the outflow of liquid water is prevented.

The fuel gas separated by the gas-liquid separator 24 is guided to the circulation flow path PA24. The ejector 23 is connected to the circulation flow path PA24. Although not shown, a purge flow path is also connected to the circulation flow path PA24. An electromagnetic purge valve that can be opened and closed is interposed in the purge flow path, and the fuel gas in the circulation flow path PA24 can be discharged to the outside through the purge flow path and the purge valve.

In the ejector 23, the fuel gas separated by the gas-liquid separator 24 is sucked in via the circulation flow path PA24 by the flow of fuel gas injected from the injector 22. The sucked-in fuel gas merges with the fuel gas that has passed through the nozzle section of the ejector 23 at the merging section of the ejector 23, and after being made into a uniform flow in the diffuser section of the ejector 23, it is supplied to the fuel cell stack 1 via the fuel gas inlet 21a.

The oxidant gas supply and exhaust part 3 includes an electric air pump 31 that generates high-pressure oxidant gas (cathode gas), an oxidant gas supply flow path PA31 that guides the oxidant gas generated by the air pump 31 to the oxidant gas inlet 31a of the fuel cell stack 1, and an oxidant gas discharge flow path PA32 through which the oxidant gas (oxidant exhaust gas) discharged from the oxidant gas outlet 31b of the fuel cell stack 1 flows. The air pump 31 may be referred as a compressor.

A humidifier 32 is arranged intersecting the oxidant gas supply flow path PA31 and the oxidant gas discharge flow path PA32. In the humidifier 32, a humidity exchange occurs between the oxidant gas and the oxidant exhaust gas, and the oxidant gas in the oxidant gas supply flow path PA31 is humidified by the moisture (water vapor) contained in the oxidant exhaust gas in the oxidant gas discharge flow path PA32.

The oxidant gas supply and exhaust part 3 further includes a bypass flow path PA33. The bypass flow path PA33 is connected to the oxidant gas supply flow path PA31 upstream of the humidifier 32 and the oxidant gas discharge flow path PA32 downstream of the humidifier 32. Through the bypass flow path PA33, the oxidant gas can flow bypassing the humidifier 32 and the fuel cell stack 1.

In the oxidant gas supply flow path PA31, an electromagnetic control valve 33 with adjustable opening is provided between the bypass flow path PA33 and the humidifier 32. In the oxidant gas discharge flow path PA32, an electromagnetic control valve 34 with adjustable opening is provided between the bypass flow path PA33 and the humidifier 32. In the bypass flow path PA33, an electromagnetic control valve 35 with adjustable opening is provided. By controlling the air pump 31 and the control valves 33 to 35, the supply amount and pressure of the oxidant gas supplied to the fuel cell stack 1 can be adjusted. Additionally, by controlling the control valves 33 to 35, the bypass amount of the oxidant gas bypassing the fuel cell stack 1 can be adjusted.

The cooling medium supply and exhaust part 4 includes a cooling device 41, a cooling medium supply flow path PA41 connecting the cooling device 41 and the cooling medium inlet 41a of the fuel cell stack 1, and a cooling medium discharge flow path PA42 connecting the cooling device 41 and the cooling medium outlet 41b of the fuel cell stack 1. Although not shown, the cooling device 41 includes a pump for pressurizing the cooling medium toward the fuel cell stack 1, a heat exchanger (radiator) for cooling the cooling medium that has been heated by passing through the fuel cell stack 1, and a cooling fan for blowing cooling air to the heat exchanger.

In the fuel gas supply flow path PA21, a pressure sensor 51 is connected downstream of the ejector 23. The pressure sensor 51 detects the inlet pressure (anode pressure Pa) of the fuel gas supplied to the fuel cell stack 1. In the oxidant gas supply flow path PA31, a pressure sensor 52 is connected downstream of the humidifier 32. The pressure sensor 52 detects the inlet pressure (cathode pressure Pc) of the oxidant gas supplied to the fuel cell stack 1.

In the cooling medium supply flow path PA41, a temperature sensor 54 is connected to detect the temperature (cooling medium inlet temperature) of the cooling medium. In the cooling medium discharge flow path PA42, a temperature sensor 55 is connected to detect the temperature (cooling medium outlet temperature) of the cooling medium. The cooling medium inlet temperature and the cooling medium outlet temperature is sometimes referred to as merely a cooling medium temperature. The cooling medium temperature may be an average of the cooling medium inlet temperature and the cooling medium outlet temperature. The gas temperatures of the fuel gas and the oxidant gas can be estimated from the cooling medium temperature.

The fuel cell system 100 according to the present embodiment is characterized by a control manner of the fuel gas supply and exhaust part 2, particularly a control manner when the drain valve 25 is switched from the open position to the closed position. This point will be described below. FIG. 3 is a block diagram illustrating a configuration of a main part of the fuel cell system 100 according to the embodiment of the present invention. As illustrated in FIG. 3, the fuel cell system 100 includes the controller 60, a current detection part 56, a pressure sensor 51, the injector 22, and the drain valve 25, which are connected to controller 60.

The current detection part 56 includes, for example, a current sensor that detects an output current of fuel cell stack 1. The output current corresponds to a power generation load. The fuel cell system 100 is configured to calculate a power (required power) or a power generation amount (required power generation amount) required by the vehicle and generate power corresponding to the required power or the required power generation amount. Therefore, the current detection part 56 may calculate the output current by using the required power or the required power generation amount. That is, the current detection part 56 may obtain, by calculation, the output current by using a parameter having a correlation with the output current instead of detecting the output current by a sensor. In other words, the current detection part 56 may be provided inside the controller 60. As described above, detecting the output current by the current detection part 56 includes obtaining the output current by calculation.

The controller 60 is a computer including an arithmetic processing device including a CPU, a ROM, a RAM, and other peripheral circuits. The controller 60 includes an injector control unit 61 and a drain control unit 62 as functional components. The controller 60 executes predetermined processing based on an output current I detected by the current detection part 56 and an anode pressure Pa detected by the pressure sensor 51, and outputs a control signal to the injector 22 and the drain valve 25.

First, the drain control unit 62 will be described. The drain control unit 62 includes a drain determination unit 620 that determines whether or not to open or close the drain valve 25. The drain control unit 62 calculates an amount of generated water generated by the power generation based on the signal from the current detection part 56, and estimates the amount of liquid water in the water storage portion 24a of the gas-liquid separator 24, that is, a water level. The water level of the water storage portion 24a gradually rises due to power generation. The drain determination unit 620 determines whether or not the water level of the water storage portion 24a has risen to a predetermined drain start position.

The drain control unit 62 maintains the drain valve 25 at the closed position until the drain determination unit 620 determines that the water level has risen to the drain start position. When the drain determination unit 620 determines that the water level has risen to the drain start position, the drain control unit 62 outputs a control signal to the drain valve 25 to switch the drain valve 25 from the closed position to the open position. Accordingly, the liquid water in the water storage portion 24a is discharged, and the water level decreases.

Thereafter, the drain determination unit 620 determines whether or not the water level of the water storage portion 24a has decreased to a drain end position, that is, whether the draining has been completed. The drain control unit 62 maintains the drain valve 25 at the open position until the drain determination unit 620 determines that the draining has been completed. When the drain determination unit 620 determines that the draining has been completed, the drain control unit 62 outputs a control signal to the drain valve 25 to switch the drain valve 25 from the open position to the closed position.

In this regard, since power is generated also during the draining, the water level fluctuates. Therefore, it is difficult to accurately determine whether or not the draining has been completed, based on the signal from the current detection part 56, and there is a risk that a timing of closing the drain valve 25 is delayed. When the closing of drain valve 25 is delayed, a part of the fuel gas flows out through drain valve 25, and the power generation efficiency is deteriorated. On the other hand, a configuration in which a water level sensor is provided in the water storage portion 24a to determine the completion of the draining causes an increase in cost. In this regard, in the present embodiment, the drain determination unit 620 is configured as follows in order to enable accurate determination, with an inexpensive configuration, as to whether or not the draining has been completed.

FIG. 4 is a time chart for explaining processing of the drain determination unit 620. More specifically, FIG. 4 is a time chart illustrating an example of an operation with the lapse of time of the injector 22 and the drain valve 25 and an example of change with the lapse of time in the anode pressure Pa detected by the pressure sensor 51. The injector 22 repeats valve opening (ON) and valve closing (OFF) at a predetermined cycle corresponding to the power generation load in accordance with a command from the injector control unit 61. The anode pressure Pa rises when the injector 22 is turned on and decreases when the injector is turned off. The rate (slope) of the rise in the anode pressure Pa is larger than the rate of the decrease in the anode pressure Pa.

That is, the anode pressure Pa rises every time the injector 22 is turned on at the time points t0, t2, t4, t7, and t9, and decreases every time the injector 22 is turned off at the time points t1, t3, t5, t8, and t10. A period T1 from time point t1 to time point t2, a period T2 from time point t3 to time point t4, a period T3 from time point t5 to time point t7, and a period T4 from time point t8 to time point t9 are pressure fall periods in which the anode pressure Pa falls. The drain valve 25 is closed at initial time point t0. At time point t6 between time points t5 and t7, when the drain determination unit 620 determines that the water level of water storage portion 24a rises to the drain start position, the drain valve 25 is opened.

The drain determination unit 620 calculates, based on the signal from the pressure sensor 51, a fall rate α (α1 to α4) of the anode pressure Pa in each pressure fall period T (T1 to T4) every time the injection of the fuel gas by the injector 22 is completed. The fall rate α is a fall amount of the anode pressure Pa per unit time, and corresponds to a slope of the characteristic in FIG. 4 showing a change in the anode pressure Pa. The fall rate α (slope) can be calculated by, for example, the least squares method. The fall rate α can also be calculated by dividing the fall amount of the anode pressure Pa in the pressure fall period T by the pressure fall period T. A fall rate α3 in the pressure fall period T3 is divided into a fall rate α3a when the drain valve 25 is closed from time point t5 to t6 and a fall rate α3b when the drain valve 25 is opened from time point t6 to t7.

While the closed state of the drain valve 25 is continued, the drain determination unit 620 calculates an average value of the fall rate α every time the fall rate α of the anode pressure Pa is calculated. For example, at time point t2, when the fall rate α1 is calculated, an average value αm of the fall rates α0 and α1 calculated up to time point t2 is calculated. At time point t4, when the fall rate α2 is calculated, an average value αm of the fall rates α0, α1, and α2 calculated up to time point t4 is calculated.

When the drain valve 25 is switched to the open position at time point t6, the drain determination unit 620 temporarily stores, in the memory, an average value of the fall rate α calculated up to time point t6 as a fall rate (referred to as closed-time fall rate αm) of the anode pressure Pa when the drain valve 25 is in the closed state. In the example of FIG. 4, the average value of the fall rates α0, α1, α2, and α3a in a period up to time point t6 is stored as the closed-time fall rate αm in the memory. When the drain valve 25 is switched to the open position in the middle of the fall in the anode pressure Pa (pressure fall period T3), the closed-time fall rate αm may be calculated excluding the fall rate α3a in the period T3. That is, the average value of the fall rates α0, α1, and α2 may be set as the closed-time fall rate αm. After storing the closed-time fall rate αm in the memory, the drain determination unit 620 resets the average value to 0 in preparation for the next processing.

Thereafter, the drain determination unit 620 calculates the fall rate α of the anode pressure Pa when the drain valve 25 is in the open state (referred as to a open-time fall rate αn). That is, an open-time fall rate α3b from time point t6 to t7 is calculated at time point t7, and an open-time fall rate α4 from time point t8 to t9 is calculated at time point t9. Until the draining of the water storage portion 24a is completed, the change in the fall rate α of the anode pressure Pa is small. On the other hand, when the draining of the water storage portion 24a is completed, a part of the fuel gas is discharged through the drain valve 25, so that the fall rate α of the anode pressure Pa increases.

In this regard, every time the open-time fall rate αn is calculated at the time points t7 and t9, the drain determination unit 620 determines whether or not a deviation Δα between the open-time fall rate αn and the closed-time fall rate αm is equal to or greater than a predetermined value Δα1. In other words, the drain determination unit 620 determines whether or not the magnitude of the open-time fall rate αn (α3b, α4) is larger than the magnitude of the closed-time fall rate αm by the predetermined value Δα1 or more. In FIG. 4, the deviation Δα between the open-time fall rate αn (α3b) and the closed-time fall rate αm calculated at time point t7 is less than the predetermined value Δα1. On the other hand, the deviation Δα between the open-time fall rate αn (α4) and the closed-time fall rate αm calculated at time point t9 becomes equal to or greater than the predetermined value Δα1.

When it is determined that the deviation Δα is equal to or greater than the predetermined value Δα1 at time point t9, the drain determination unit 620 determines that the draining has been completed. When the drain determination unit 620 determines that the draining has been completed, the drain control unit 62 outputs a control signal to the drain valve 25 to switch the drain valve 25 to the closed position. Accordingly, the discharge of the fuel gas to the outside is prevented. When the drain valve 25 is switched to the open position in the middle of the fall in the anode pressure Pa (pressure fall period T3), the open-time fall rate αn may be calculated excluding the fall rate α3b in the period T3. By adding the error and margin of the pressure sensor 51 to the closed-time fall rate αm to correct the closed-time fall rate αm, and calculating the deviation Δα between the corrected closed-time fall rate αm and the open-time fall rate αn, the drain determination unit 620 may determine whether or not the draining has been completed.

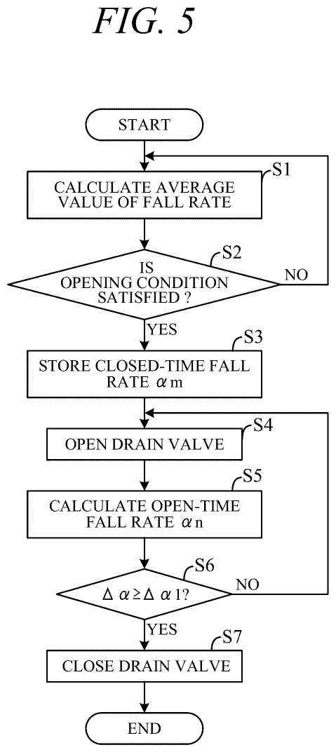

FIG. 5 is a flowchart illustrating an example of processing executed by the drain control unit 62 of the controller 60. The processing illustrated in the flowchart is started every time drain valve 25 is switched to the closed position. The controller 60 executes the processing of the flowchart of FIG. 5 to obtain the operation of FIG. 4. Hereinafter, for convenience, the flowchart of FIG. 5 will be described with reference to the parameters of FIG. 4.

As illustrated in FIG. 5, first, in S1 (S: processing step), the controller 60 calculates the fall rate α of the anode pressure Pa, based on the signal from the pressure sensor 51 every time the injection of the fuel gas by the injector 22 is completed. Further, the controller 60 calculates the average value of the fall rate α during the closing period of the drain valve 25. Next, in S2, the controller 60 determines whether or not an opening condition of the drain valve 25 is satisfied, based on the signal of the current detection part 56. The opening condition is satisfied, for example, when the water level of the liquid water calculated based on the signal from current detection part 56 rises to the drain start position. When an affirmative determination is made in S2, the processing proceeds to S3, and when a negative determination is made, the processing returns to S1.

In S3, the controller 60 stores, in the memory, the closed-time fall rate αm that is an average value of the fall rates α calculated until the opening condition is satisfied. Next, in S4, the controller 60 outputs a control signal to the drain valve 25 to switch the drain valve 25 from the closed position to the open position. Accordingly, the liquid water in the water storage portion 24a is discharged to the outside through the drain valve 25. Next, in S5, the controller 60 calculates the open-time fall rate αn which is the fall rate α of the anode pressure Pa, based on the signal from the pressure sensor 51 every time the injection of the fuel gas by the injector 22 is completed.

Next, in S6, the controller 60 calculates the deviation Δα between the closed-time fall rate αm and the open-time fall rate αn, and determines whether or not the deviation Δα is equal to or greater than the predetermined value Δα1. When an affirmative determination is made in S6, the processing proceeds to S7, and when a negative determination is made, the processing returns to S5. In S7, the controller 60 outputs a control signal to the drain valve 25 to switch the drain valve 25 from the open position to the closed position. This is the end of the processing of the flowchart of FIG. 5.

As described above, in the present embodiment, since the fall rate α of the anode pressure Pa is calculated based on the detection value of the pressure sensor 51, without using a water level sensor or the like, it is possible to determine whether or not the draining from the water storage portion 24a has been completed. That is, when the draining is completed, the fuel gas is discharged to the outside through the drain flow path PA23, so that the fall rate α of the anode pressure Pa increases. Since whether or not the draining has been completed is determined in consideration of this point, whether or not the draining has been completed can be accurately determined with an inexpensive configuration not using a water level sensor or the like.

Next, the injector control unit 61 of FIG. 3 will be described. The injector control unit 61 calculates a target flow rate of the fuel gas corresponding to the required power, and outputs a control signal to the injector 22 so that the fuel gas corresponding to the target flow rate is supplied to the fuel cell stack 1. More specifically, the injector control unit 61 calculates a target injection cycle and a target injection amount (duty ratio) of the injector 22, and controls the injector 22 to inject fuel gas according to the target injection cycle and the target injection amount. The controller 60 may calculate the targe flow rate according to the required power generation amount but the required power.

In this case, the injector control unit 61 first determines an injection mode corresponding to the power generation load (required power) by a mode determination unit 610. The injection mode is classified into a first injection mode M1 in which only a single large injector 221 performs injection, a second injection mode M2 in which the single large injector 221 and a small injector 224 perform injection, a third injection mode M3 in which a pair of large injectors 221 and 222 perform injection, and a fourth injection mode M4 in which all large injectors 221 to 223 perform injection. The large injector 22 that injects in the first injection mode M1 and the second injection mode M2 may not be a single injector, and for example, the number of injectors 22 that perform injection may be increased as the required hydrogen amount is larger, or a predetermined number of injectors 22 may be used.

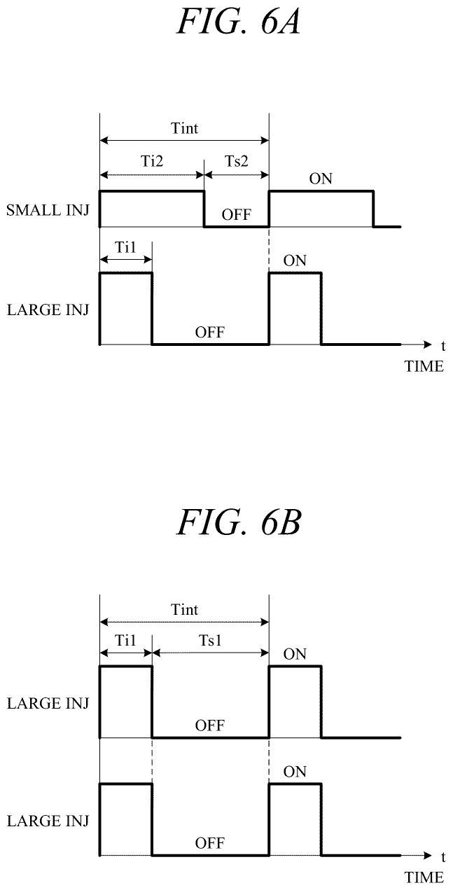

FIG. 6A is a diagram illustrating an example of injection patterns of the large injector 221 and the small injector 224 in the second injection mode M2. In FIG. 6A, a horizontal axis represents time, and a vertical axis (height of pulse) represents an injection amount per unit time. As illustrated in FIG. 6A, in the second injection mode M2, the fuel gas is injected from the large injector 221 and the small injector 224 along a pulse waveform at an injection cycle Tint corresponding to the power generation load. More specifically, the large injector 221 and the small injector 224 are turned on at the same timing, and an injection start timing is the same. However, a valve opening time Ti1 of the large injector 221 is shorter than a valve opening time Ti2 of the small injector 224. Therefore, the injection timings of the large injector 221 and the small injector 224 are different from each other. In FIG. 6A, although the injection timings of the large injector 221 and the small injector 224 partially overlap, the injection timings may be offset so as not to overlap each other. That is, the small injector 224 may be injected after the large injector 221 is injected.

FIG. 6B is a diagram illustrating an example of injection patterns of the large injectors 221 and 222 in the third injection mode M3. As illustrated in FIG. 6B, also in the third injection mode M3, the fuel gas is injected from the large injectors 221 and 222 along the pulse waveform at the injection cycle Tint corresponding to the power generation load. More specifically, the large injectors 221 and 222 are turned on at the same timing, and have the same injection start timing. In addition, the large injectors 221 and 222 also have the same valve opening time Ti1. Therefore, the injection timings of the large injectors 221 and 222 coincide with each other.

Although not illustrated, the injection patterns of the large injectors 221 to 223 in the fourth injection mode M4 are also similar to those illustrated in FIG. 6B. That is, also in the fourth injection mode M4, the large injectors 221 to 223 are turned on at the same timing, and have the same injection start timing. In addition, the large injectors 221 to 223 also have the same valve opening time Ti1. Therefore, the injection timings of the large injectors 221 to 223 coincide with each other.

Here, within the injection cycle Tint, a time during which any of a plurality of injectors 221 to 224 injects fuel gas is defined as an injection time, and a time during which none of the plurality of injectors 221 to 224 injects fuel gas is defined as a non-injection time. As illustrated in FIG. 6A, the injection time in the second injection mode M2 is equal to the valve opening time Ti2 of the small injector 224, and the non-injection time is a time Ts2 obtained by subtracting the valve opening time Ti2 from the injection cycle Tint.

On the other hand, as illustrated in FIG. 6B, the injection time in the third injection mode M3 is equal to the valve opening time Ti1 of the large injectors 221 and 222, and the non-injection time is a time Ts1 obtained by subtracting the valve opening time Ti1 from the injection cycle Tint. Similarly in the fourth injection mode M4, the non-injection time is the time Ts1 obtained by subtracting the valve opening time Ti1 from the injection cycle Tint. As described above, in the third injection mode M3 and the fourth injection mode M4, the injection timings of the plurality of large injectors 221 and 222 and the large injectors 221 to 223 coincide with each other. Therefore, the non-injection times Ts1 of the third injection mode M3 and the fourth injection mode M4 are longer than the non-injection time Ts2 of the second injection mode M2.

In the present embodiment, as described above, the controller 60 calculates the fall rate α of the anode pressure Pa every time the injection of the fuel gas by the injector 22 is completed, and determines whether or not the draining has been completed, based on the fall rate α. Therefore, in order to accurately determine whether or not the draining has been completed, it is necessary to accurately calculate the fall rate α, and for this purpose, it is preferable that decrease time of the anode pressure Pa, i.e., the non-injection time is long. In consideration of this point, the mode determination unit 610 determines the injection mode such that the third injection mode M3 and the fourth injection mode M4 are preferentially adopted rather than the second injection mode M2.

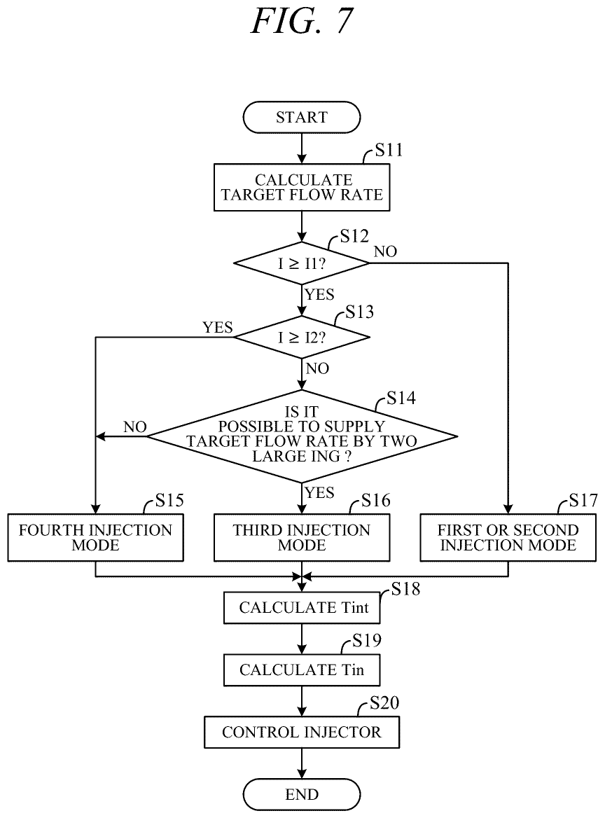

FIG. 7 is a flowchart illustrating an example of processing executed by the injector control unit 61 of the controller 60. The processing illustrated in this flowchart is started, for example, when the change in the power generation load becomes a small steady state, and is repeated at a predetermined cycle while the steady state continues.

As illustrated in FIG. 7, first, in S11, the controller 60 calculates the target flow rate of the fuel gas corresponding to the output current I detected by the current detection part 56. Next, in S12, the controller determines whether or not the output current I is equal to or greater than a predetermined value I1. This determination is a determination as to whether or not the power generation load is a low load, and the predetermined value I1 is set to a value for distinguishing between the low load and the medium load. When an affirmative determination is made in S12, the processing proceeds to S13, and when a negative determination is made, the processing proceeds to S17.

In S17, the controller 60 determines the injection mode to be the first injection mode M1 or the second injection mode M2. For example, a predetermined value I3 smaller than the predetermined value I1 is set, the first injection mode M1 is determined when the output current I is equal to or less than the predetermined value I3, and the second injection mode M2 is determined when the output current I is equal to or greater than the predetermined value I3 and less than the predetermined value I1. The predetermined value I3 is set to a value for distinguishing between the low load and the extremely low load. Therefore, the controller 60 determines the injection mode to be the first injection mode M1 when the load is an extremely low load, and determines the injection mode to be the second injection mode M2 when the load is a low load. The injector 22 can perform injection in the second injection mode M2 even when the output current I is larger than the predetermined value I1, but from the viewpoint of prioritizing the third injection mode M3 and the fourth injection mode M4 over the second injection mode M2 as described above, in the present embodiment, the predetermined value I1 is set to be low.

In S13, the controller 60 determines whether or not the output current I detected by the current detection part 56 is equal to or greater than a predetermined value I2. This determination is a determination as to whether or not the power generation load is a medium load. The predetermined value I2 is larger than the predetermined value I1, and is set to a value for distinguishing between the medium load and the high load. When an affirmative determination is made in S13, the processing proceeds to S15. In S15, the controller 60 determines the injection mode to be the fourth injection mode M4. The predetermined value I1 may be a value for distinguishing between the low load and the extremely low load, and the predetermined value I2 may be a value for distinguishing between the low load and the medium load.

On the other hand, when a negative determination is made in S13, the processing proceeds to S14. In S14, the controller 60 determines whether or not the target flow rate of the fuel gas corresponding to the output current I can be supplied by a pair of large injectors 221 and 222. Since S14 is processing executed when the output current I is less than the predetermined value I2, an affirmative determination is made normally. However, the target flow rate of the fuel gas may exceed the supply capacities of the injectors 221 and 222, and in this case, a negative determination is made in S14. When an affirmative determination is made in S14, the processing proceeds to S16, and when a negative determination is made, the processing proceeds to S15. In S16, the controller 60 determines the injection mode to be the third injection mode.

The above processing of S11 to S17 is executed by the mode determination unit 610. When the injection mode is determined in S15 to S17, the processing proceeds to S18. In S18, the controller 60 calculates the target injection cycle Tint corresponding to the output current I detected by the current detection part 56. The target injection cycle Tint is set to a shorter value as the output current I increases. In consideration of not only the output current I but also the anode pressure Pa, the target injection cycle Tint may be shortened as the anode pressure Pa (strictly, the hydrogen partial pressure considering a hydrogen concentration) is smaller.

The controller 60 can obtain the target injection cycle Tint using a predetermined map or by an arithmetic expression. The predetermined map is, for example, a map that defines a relationship between the target flow rate and the target injection cycle Tint such that the target injection cycle Tint rapidly decreases as the target flow rate increases in a region where the target flow rate of the fuel gas is small and the target injection cycle Tint gradually decreases as the target flow rate increases in a region where the target flow rate is large. When the target flow rate is equal to or greater than a predetermined value, the target injection cycle Tint may be set to a constant lower limit value.

Next, in S19, the controller 60 calculates a target injection amount (referred to as a unit injection amount) for each injection cycle Tint of the plurality of injectors 221 to 224 according to the injection mode. In this case, first, the controller 60 calculates a target injection amount (referred to as a total injection amount) of the injection cycle Tint when the single injector 22 is used. Next, in the third injection mode, the controller 60 calculates the unit injection amount by dividing the total injection amount by 2, and in the fourth injection mode, the controller 60 calculates the unit injection amount by dividing the total injection amount by 3. In the first injection mode, the controller 60 calculates the total injection amount as it is as the unit injection amount.

In the second injection mode, the controller 60 determines the injection rates of the large injector 221 and the small injector 224 according to a predetermined map, and calculates each unit injection amount. The predetermined map is a map in which the injection rate of the large injector 221 increases as the total injection amount increases, for example. The unit injection amount is proportional to a valve opening time Ti1 and Ti2 of the injector 22. Therefore, the controller 60 calculates the target valve opening time Ti of each of the injectors 221 to 224 according to the unit injection amount.

Next, in S20, the controller 60 outputs a control signal to the injector 22 so that each of the injectors 221 to 224 opens for the target valve opening time Ti at the target injection cycle Tint.

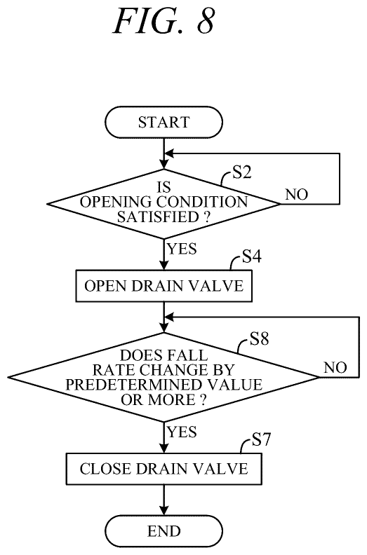

In the above description, the controller 60 determines whether or not the draining of the liquid water stored in the water storage portion 24a has been completed, by comparing the fall rate α in the anode pressure Pa when the drain valve 25 is closed with the fall rate α in the anode pressure Pa when the drain valve is opened. However, the controller may determine whether or not the draining has been completed, based on a change in the fall rate α in the anode pressure Pa when the drain valve 25 is opened. FIG. 8 is a flowchart illustrating an example of processing executed by the controller 60 in that case. FIG. 8 is a modification of FIG. 5, and as in FIG. 5, every time the drain valve 25 is switched to the closed position, the processing illustrated in the flowchart of FIG. 8 is started. The same processing as that in FIG. 5 is denoted by the same reference numeral.

In FIG. 8, in a state where drain valve 25 is switched to the closed position, it is not necessary to calculate the average value of the fall rates α of the anode pressure Pa. Therefore, the processing of S1 is omitted, and the processing is started from S2. As illustrated in FIG. 8, in S2, the controller 60 determines whether or not the opening condition of drain valve 25 is satisfied, based on the signal from current detection part 56. S2 is repeated until an affirmative determination is made. When an affirmative determination is made in S2, the processing proceeds to S4, and the controller 60 outputs a control signal to the drain valve 25 to switch the drain valve 25 from the closed position to the open position.

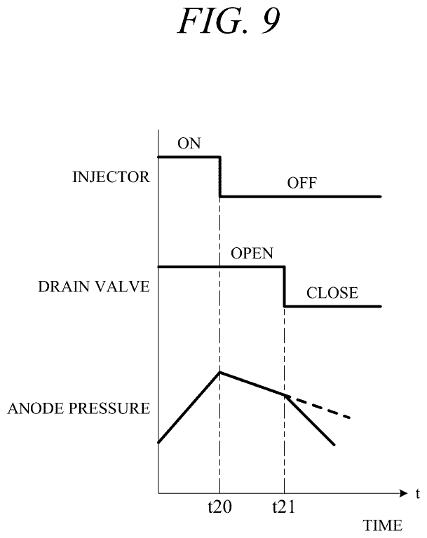

Next, in S8, the controller 60 determines whether or not the change in the fall rate α of the anode pressure Pa is equal to or greater than a predetermined value, based on the signal from the pressure sensor 51. FIG. 9 is a time chart illustrating an example of an operation obtained by the processing of FIG. 8. As illustrated in FIG. 9, when the injector 22 is turned off at time point t20, the anode pressure Pa falls. At this time, if the draining of the liquid water stored in the water storage portion 24a is not completed, the fall rate α at the time of non-injection of the fuel gas is constant or substantially constant even after time point t21 as indicated by a dotted line. On the other hand, when the draining is completed, the fall rate α increases by a predetermined value or more at time point t21 as indicated by a solid line. In this regard, in S8, the controller 60 determines whether or not the fall rate α of the anode pressure Pa increases by the predetermined value or more.

S8 is repeated until an affirmative determination is made. When an affirmative determination is made in S8, the processing proceeds to S7, and the controller 60 outputs a control signal to the drain valve 25 to switch the drain valve 25 from the open position to the closed position (see FIG. 9). This is the end of the processing of the flowchart of FIG. 8.

According to the present embodiment, the following operations and effects are achievable.

(1) A fuel cell system 100 includes: a fuel cell stack 1 (fuel cell) that generates power by being supplied with fuel gas (anode gas) and oxidant gas (cathode gas); an injector 22 that injects the fuel gas supplied to the fuel cell stack 1 through a fuel gas supply flow path PA21 (anode gas supply flow path); a water storage portion 24a of a gas-liquid separator 24 that is provided in a fuel gas discharge flow path PA22 (anode gas discharge flow path) through which the fuel gas discharged from the fuel cell stack 1 flows and in which liquid water generated by power generation of the fuel cell stack 1 is stored; a drain valve 25 that is provided in a drain flow path PA23 connected to the water storage portion 24a; a pressure sensor 51 that detects an anode pressure Pa that is a pressure of the fuel gas in the fuel gas supply flow path PA21; a current detection part 56 that detects an output current as a power generation load; and a controller 60 that controls (duty control) the injector 22 so as to alternate between injection and non-injection of the fuel gas according to the output current detected by the current detection part 56, and switches the drain valve 25 from an open position (open state) for opening the drain flow path PA23 to a closed position (closed state) for blocking the drain flow path PA23, according to the anode pressure Pa detected by the pressure sensor 51 (FIGS. 1 and 3). The controller 60 switches the drain valve 25 from the open position to the closed position, based on the fall rate α of the anode pressure Pa detected by the pressure sensor 51 during non-injection of the fuel gas by the injector 22 (FIGS. 4 and 5).

As described above, the drain valve 25 is switched from the open position to the closed position based on the fall rate α of the anode pressure Pa detected by the pressure sensor 51, so that it is possible to favorably determine whether or not draining of the liquid water stored in water storage portion 24a has been completed, with an inexpensive configuration without using a water level sensor or the like, whereby the drain valve 25 can be switched to the closed position at favorable timing.

(2) The controller 60 switches the drain valve 25 from the open position to the closed position, based on a deviation Δα between a closed-time fall rate αm which is a fall rate α of the anode pressure Pa detected by the pressure sensor 51 in a state where the drain valve 25 is switched to the closed position during non-injection of the fuel gas by the injector 22 and an open-time fall rate αn which is a fall rate α of the anode pressure Pa detected by the pressure sensor 51 in a state where the drain valve 25 is switched to the open position during non-injection of the fuel gas by the injector 22 (FIG. 5). When draining is completed, the fuel gas is discharged to the outside through the drain flow path PA23, so that the fall rate α of the anode pressure Pa increases. In consideration of this point, whether or not draining has been completed is determined based on the deviation Δα between the closed-time fall rate αm and the open-time fall rate αn of the anode pressure Pa, so that it is possible to favorably determine whether or not draining has been completed and to switch the drain valve 25 to the closed position without delay.

(3) When deviation Δα becomes equal to or greater than a predetermined value Δα1, the controller 60 switches the drain valve 25 from the open position to the closed position (FIG. 5). Accordingly, it is possible to accurately determine whether or not draining has been completed and to switch the drain valve 25 to the closed position at an optimum timing.

(4) The injector 22 has a plurality of injectors 221 to 224 (FIG. 1). When the output current I detected by the current detection part 56 is equal to or greater than a predetermined value I1, the controller 60 controls the injector 22 such that injection timings of a plurality of injectors 221 and 222 or 221 to 223 coincide with each other (FIGS. 6B and 7). Accordingly, a non-injection time Ts1 of the injector 22 can be lengthened, and the fall rate α of the anode pressure Pa can be calculated favorably.

(5) When the output current I detected by the current detection part 56 is less than the predetermined value I1, the controller 60 controls the injector 22 such that injection timings of a plurality of injectors 221 and 224 do not coincide with each other (FIGS. 6A and 7). Accordingly, it is possible to easily perform low load power generation corresponding to the required power.

(6) The plurality of injectors 221 to 224 includes a plurality of large injectors 221 to 223 having the same injection capability and a small injector 224 having an injection capability smaller than those of the large injectors 221 to 223 (FIG. 1). The controller 60 controls the injector 22 such that when the output current I detected by the current detection part 56 is equal to or greater than the predetermined value I1, the plurality of large injectors 221 and 222 or 221 to 223 injects the fuel gas at mutually equal injection timings, and when the output current I is less than the predetermined value I1, the single large injector 221 and the small injector 224 inject the fuel gas at mutually different injection timings (FIGS. 6A, 6B, and 7). Accordingly, it is possible to lengthen the non-injection time Ts1 in the predetermined injection modes M3 and M4 while performing power generation corresponding to the required power.

(7) The plurality of large injectors 221 to 223 includes three large injectors 221 to 223 that are provided in parallel with each other (FIG. 1). The controller 60 controls the injector 22 such that when the output current I detected by the current detection part 56 is equal to or greater than the predetermined value I1 (first predetermined value) and less than the predetermined value I2 (second predetermined value), two large injectors 221 and 222 inject the fuel gas (third injection mode M3), and when the output current I is equal to or greater than the predetermined value I2, three large injectors 221 to 223 inject the fuel gas (fourth injection mode M4) (FIG. 7). Accordingly, when the output current I is equal to or greater than the predetermined value I1, even if the fuel gas can be injected by three large injectors 221 to 223 in the fourth injection mode M4, the fuel gas is injected by two large injectors 221 and 222 in the third injection mode M3, so that a frequency of use of the large injector 223 can be reduced and durability can be improved.

(8) The controller 60 calculates a target flow rate of the fuel gas according to the output current I detected by the current detection part 56, and controls the injector 22 such that when the target flow path is greater than an injectable amount of two large injectors 221 and 222, three large injectors 221 to 223 inject the fuel gas even when the output current I is equal to or greater than the predetermined value I1 and less than the predetermined value I2 (FIG. 7). Therefore, when the output current I is equal to or greater than the predetermined value I1 and less than the predetermined value I2, the third injection mode M3 is prioritized over the fourth injection mode M4, and the injector 22 can be efficiently used in consideration of the durability of the injector 22.

(9) When a rate of change in the fall rate α of the anode pressure Pa detected by the pressure sensor 51 becomes greater than a predetermined value in a state where the drain valve 25 is switched to the open position, the controller 60 may switch the drain valve 25 from the open position to the closed position (FIG. 8). Accordingly, it is possible to determine, at an early stage, whether or not the draining has been completed and to minimize the outflow of the fuel gas from the drain valve 25. In this case, instead of the change in fall rate α, when the fall rate α becomes greater than a predetermined value, the drain valve 25 may be switched from the open position to the closed position.

The above embodiment can be modified to various forms. Hereinafter, some modified examples will be described. In the above embodiment, the power generation current is detected by a current sensor as the current detection part 56, but a power generation load may be detected by other sensors or by calculation, and the configuration of a load detection part is not limited to that described above. In the above embodiment, the pressure sensor 51 is provided in the fuel gas supply flow path PA21. However, as long as the pressure of the anode gas in the anode supply flow path can be detected, the configuration of a pressure detection part is not limited to that described above. In the above embodiment, the water stored in the water storage portion 24a of the gas-liquid separator 24 is discharged through the drain valve 25. However, the configuration of a water storage portion may be any configuration as long as it is provided in the anode gas discharge flow path to store liquid water generated by the power generation of the fuel cell.

In the above embodiment, the controller 60 as a control unit controls the injector 22 to repeat injection and non-injection of the fuel gas according to the power generation load, and switches the drain valve 25 from the open position to the closed position according to the anode pressure Pa. More specifically, when the deviation Δα between the closed-time fall rate αm (first decrease rate) of the anode pressure Pa in the state where the drain valve 25 is switched to the closed position and the open-time fall rate αn (second decrease rate) of the anode pressure Pa in the state where the drain valve 25 is switched to the open position becomes equal to or greater than a predetermined value Δα1, the drain valve 25 is switched from the open position to the closed position, but the configuration of the control unit may be any configuration as long as the drain valve 25 is switched to the closed state based on the decrease rate of the anode pressure Pa during non-injection of the anode gas by the injector 22.

In the above embodiment, the injector 22 has multiple large injectors 221 to 223 provided in parallel with each other, and in the third injection mode M3, two (a first predetermined number) large injectors 221 and 222 inject the fuel gas, and in the fourth injection mode M4, three (a second predetermined number) large injectors 221 to 223 inject the fuel gas. However, the first predetermined number and the second predetermined number are not limited to those described above as long as the second predetermined number is greater than the first predetermined number. Therefore, the configuration of the injector 22 is not limited to that described above. For example, the injector 22 may be configured by multiple injectors having equal injection amount capabilities. The injector 22 may be configured by a single injector.

In the above example, the fuel cell system 100 was explained in the context of its application to a fuel cell vehicle, but the fuel cell system of this invention can also be applied to other than fuel cell vehicles.

The above embodiment can be combined as desired with one or more of the above modifications. The modifications can also be combined with one another.

According to the invention, it is possible to switch a drain valve from an open state to a closed state with an inexpensive configuration without using a water level sensor.

Above, while the present invention has been described with reference to the preferred embodiments thereof, it will be understood, by those skilled in the art, that various changes and modifications may be made thereto without departing from the scope of the appended claims.

What is claimed is:

1. A fuel cell system comprising:
a fuel cell that generates power by being supplied with an anode gas and a cathode gas;
an injector that injects the anode gas supplied to the fuel cell through an anode supply flow path;
a water storage portion provided in an anode gas discharge flow path through which the anode gas discharged from the fuel cell flows, a liquid water generated by power generation of the fuel cell being stored in the water storage portion;
a drain valve provided in a drain flow path connected to the water storage portion;
a pressure detection part that detects a pressure of the anode gas in the anode supply flow path;
a load detection part that detects a power generation load; and
an electronic control unit including a microprocessor and a memory connected to the microprocessor, wherein
the microprocessor is configured to perform
controlling the injector to alternate between an injection and a non-injection of the anode gas in accordance with the power generation load, and
controlling the drain valve to switch from an open position opening the drain flow path to a closed position blocking the drain flow path in accordance with the pressure detected by the pressure detection part,
the controlling the drain valve including switching the drain valve from the open position to the closed position based on a decrease rate of the pressure detected by the pressure detection part during the non-injection of the anode gas by the injector.

2. The fuel cell system according to claim 1, wherein
the microprocessor is configured to perform
the controlling the drain valve including switching the drain valve from the open position to the closed position based on a deviation between a first decrease rate and a second decrease rate, the first decrease rate being a decrease rate of the pressure detected by the pressure detection part in a state where the drain valve has been switched to the closed position during the non-injection of the anode gas by the injector, the second decrease rate being a decrease rate of the pressure detected by the pressure detection part in a state where the drain valve has been switched to the open position during the non-injection of the anode gas by the injector.

3. The fuel cell system according to claim 2, wherein
the microprocessor is configured to perform
the controlling the drain valve including switching the drain valve from the open position to the closed position when the deviation becomes equal to or greater than a predetermined value.

4. The fuel cell system according to claim 1, further comprising
a plurality of injectors including the injector, wherein
the microprocessor is configured to perform
the controlling the injector including controlling the plurality of injectors such that injection timings of the plurality of injectors coincide with each other when the power generation load is equal to or greater than a predetermined value.

5. The fuel cell system according to claim 4, wherein
the microprocessor is configured to perform
the controlling the injector including controlling the plurality of injectors such that the timings of the plurality of injectors do not coincide when the power generation load is less than the predetermined value.

6. The fuel cell system according to claim 5, wherein
the plurality of injectors include a plurality of large injectors having an injection capability equal to each other and a small injector having an injection capability smaller than the injection capability of the plurality of large injectors, and
the microprocessor is configured to perform
the controlling the injector including controlling the plurality of injectors such that when the power generation load is equal to or greater than the predetermined value, the plurality of large injectors inject the anode gas at an injection timing equal to each other, and when the power generation load is less than the predetermined value, at least one of the plurality of large injectors and the small injector inject the anode gas at an injection timing different from each other.

7. The fuel cell system according to claim 4, wherein
the plurality of large injectors include a second predetermined number of large injectors provided in parallel with each other, the second predetermined number being greater than a first predetermined number, and
the microprocessor is configured to perform
the controlling the injector including controlling the plurality of injectors such that when the power generation load is equal to or greater than a first predetermined value and less than a second predetermined value, the first predetermined number of large injector injects the anode gas, and when the power generation load is equal to or greater than the second predetermined value, the second predetermined number of large injectors inject the anode gas.

8. The fuel cell system according to claim 7, wherein
the microprocessor is configured to perform
the controlling the injector including calculating a target flow rate of the anode gas in accordance with the power generation load, and controlling the plurality of injectors such that when the target flow rate is greater than an injectable amount by the first predetermined number of large injector, the second predetermined number of large injectors inject the anode gas even when the power generation load is equal to or greater than the first predetermined value and less than the second predetermined value.

9. The fuel cell system according to claim 1, wherein
the microprocessor is configured to perform
the controlling the drain valve including switching the drain valve from the open position to the closed position when the decrease rate of the pressure detected by the pressure detection part or a rate of change in the decrease rate of the pressure becomes greater than a predetermined value.

10. The fuel cell system according to claim 1, wherein
the microprocessor is configured to perform
the controlling the drain valve including estimating a water level of the liquid water stored in the water storage portion based on a signal from the load detection part, and switching the drain valve from the closed position to the open position when the water level becomes equal to or greater than a predetermined value.
